(19) United States
(12) Patent Application Publication
(10) Pub. No.: US 2004/0191732 A1
(43) Pub. Date: Sep. 30, 2004

(54) Sine of the time

(76) Inventor: Eric William Anderson, Ormond Beach, FL (US)

Correspondence Address: Eric Anderson, 7 Soco Trail, Ormond Beach, FL, 32174, US

(21) Appl. No.: 10/794,921

(22) Filed: Mar. 8, 2004

Related U.S. Application Data
(60) Provisional application No. 60/456,514, filed on Mar. 24, 2003.

(51) Int. Cl. G09B 19/02

(52) U.S. Cl. 434/188

(57) ABSTRACT

This is the introduction of Trigonometry by the method of factoring all three full-circle units of angle measure (i.e. 360 Degrees, 400 Grads, and 2π Radians) into 24 parts which parts are represented by the hours of the day as displayed on the face of a 24-hour time-piece.

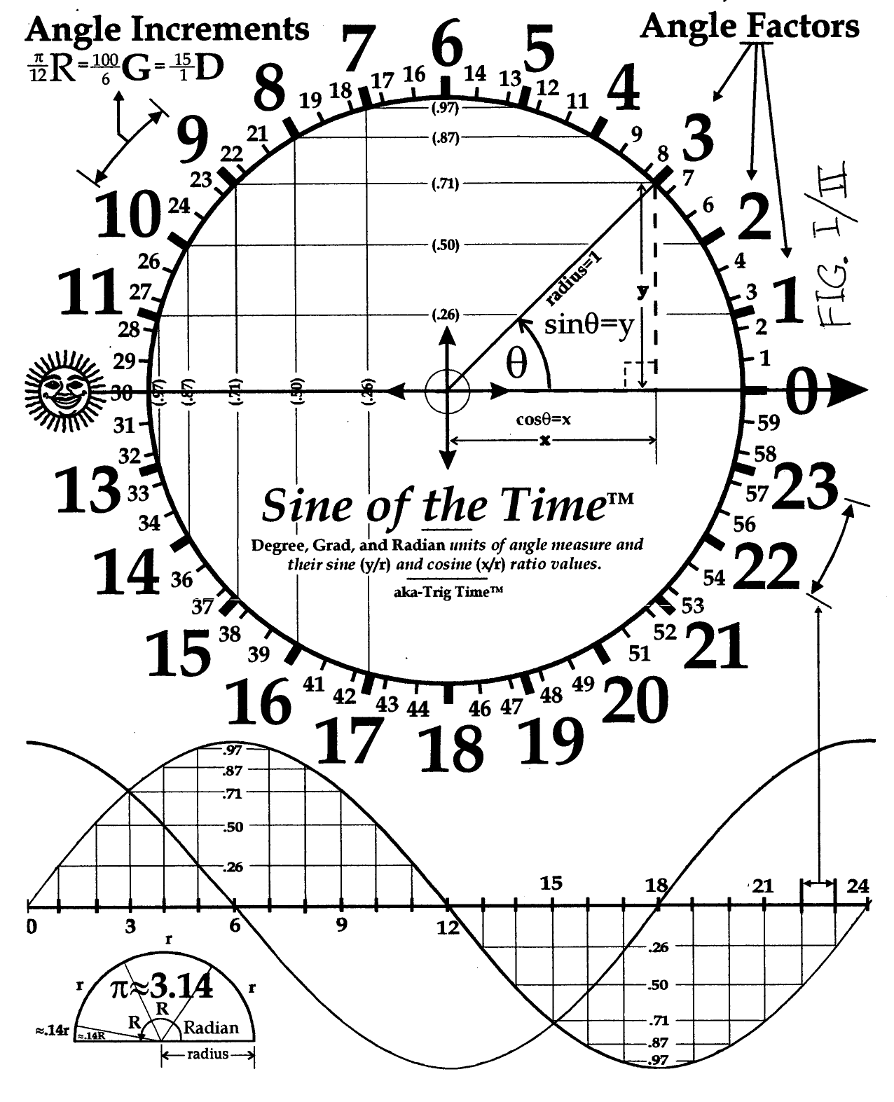

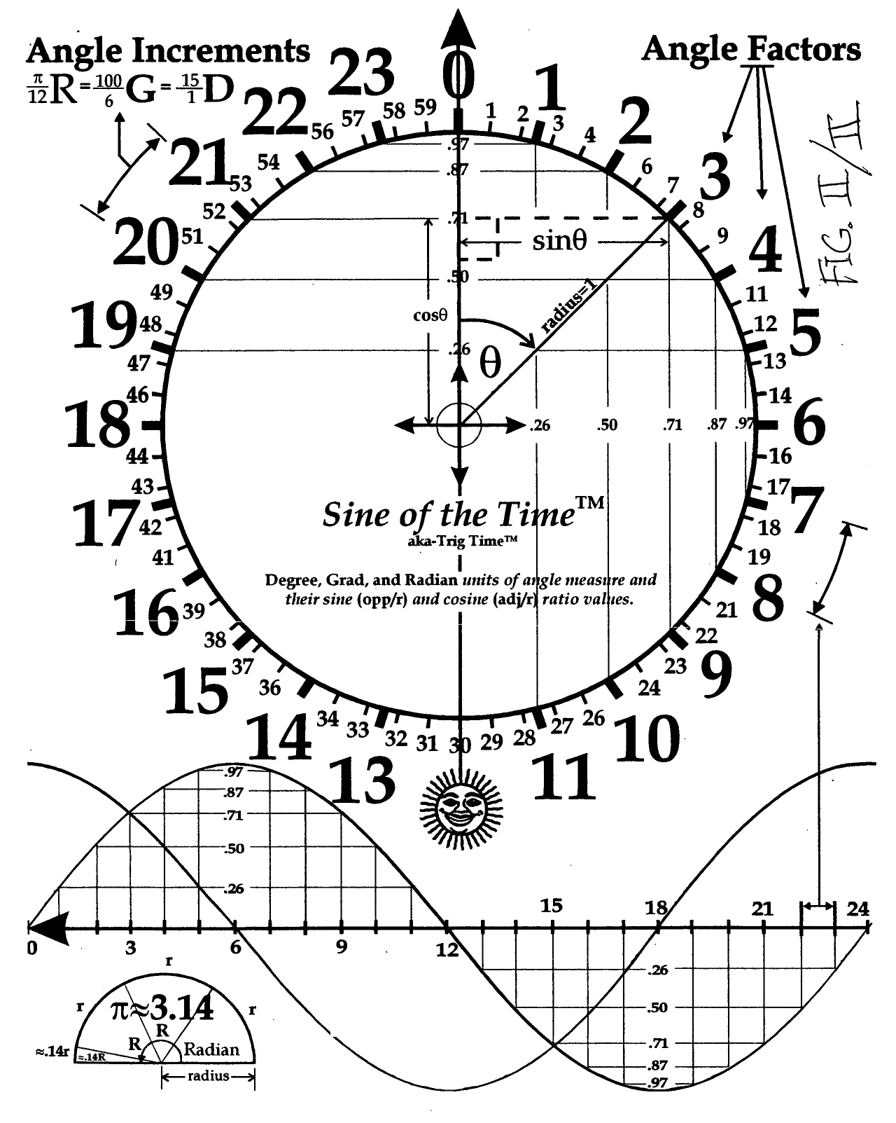

### CROSS-REFERENCE TO RELATED APPLICATIONS

I am filing to convert Provisional Patent Application No. 60/456,514 into a Non-Provisional patent. Filing date of the Provisional Patent Application was Mar. 24, 2003 (Confirmation No. 9766).

### STATEMENT REGARDING FEDERALLY SPONSORED RESEARCH

Applicable.

### REFERENCE TO SEQUENCE LISTING

Not Applicable.

### BACKGROUND OF THE INVENTION

This invention pertains to the field of math (trigonometry and geometry), and time (the rotation of the earth). It synchronizes the traditional trigonometry angle-measure diagram, with a 24-hour clock face (or vice-versa). Additionally, it incorporates all three units of angle measure onto the diagram; Degress, Grads, and Radians.

All common scientific calculators have a MODE selector that allows the user to choose the unit of angle measure (again, this is Degrees, Grads, or Radians) in which they need to, or desire to, measure angles. This invention gives a comprehensive visual relevance to those available choices.

### BRIEF SUMMARY OF THE INVENTION

One of the advantages of this invention is the introduction of Trigonometry in relation to something that is so universally well known (i.e. A common clock face/rotation of the earth). It also serves to bring together all three units of angle measure into one diagram, that diagram being the incorporated time-clock face. The object is to teach Trigonometry, geometry, and time (etcetera) in a more visually relevant (i.e. Prima facie) manner.

### BRIEF DESCRIPTION OF THE SEVERAL VIEWS OF THE DRAWING

FIG. I: This drawing shows the invention with the clock face read in a non-conventional counter-clockwise direction, and the trigonometry in its conventional counter-clockwise direction.

FIG. II: This drawing shows the invention with the clock face read in one of its conventional clockwise directions (with ‘midnight’ in the top position), and the trigonometry in a non-conventional clockwise direction.

### DETAILED DESCRIPTION OF THE INVENTION

Relevant angle measures are derived by multiplying a number that represents the hour of the day by one of the given increments of the units of angle measure, which unit is selected by the users need or choice. The product of said multiplication yields the angle measure represented at the center of the clock face, between the zero-line and the line/hour from which the measure is observed. Note that the ‘rounded’ Sine and Cosine values of the ‘on-the-hour’ angles are shown, and these values may be verified by the student of mathematics by solving the relevant trigonometric function by hand or on a scientific calculator. This invention is produced with a single, finger rotated plastic hand, or with a functioning 24-hour clock mechanism, etcetera.

1. I claim to invent a better method (at once, clearer and more comprehensive) of introducing the subject of Trigonometry by relating it to the common 24-hour clock-face/rotation-of-the-earth, and incorporating all three units of angle measure within said introduction.
